(19) United States
(12) Patent Application Publication
(10) Pub. No.: US 2026/0269414 A1
(43) Pub. Date: Sep. 10, 2026

(54) TRACTION BATTERY PACK ASSEMBLY HAVING CELL HOLDER AND WEDGE

(71) Applicant: Ford Global Technologies, LLC, Dearborn, MI (US)

(72) Inventors: Yi Zhang, Ann Arbor, MI (US); Antony George Schepak, Howell, MI (US); Patrick Daniel Maguire, Ann Arbor, MI (US); Daniel Benjamin Kok, Ann Arbor, MI (US)

(21) Appl. No.: 19/304,658

(22) Filed: Aug. 20, 2025

Related U.S. Application Data
(60) Provisional application No. 63/766,671, filed on Mar. 4, 2025.

(51) Int. Cl. H01M 50/291; B60L 50/64; B60L 58/26; H01M 10/613; H01M 10/625; H01M 10/643; H01M 10/6567; H01M 50/213; H01M 50/227; H01M 50/249; H01M 50/278; H01M 50/293

(52) U.S. Cl. CPC H01M 50/291; B60L 50/64; B60L 58/26; H01M 10/613; H01M 10/625; H01M 10/643; H01M 10/6567; H01M 50/213; H01M 50/227; H01M 50/249; H01M 50/278; H01M 50/293; H01M 2220/20

(57) ABSTRACT

A traction battery pack assembly includes a cell holder assembly having a plurality of pockets. Each pocket is established by at least one sidewall that tapers inward from the first end region of the pocket toward the opposite second end region of the pocket. Each pocket is configured to receive at least one battery cell. At least one wedge is associated with each pocket. The wedge is disposed between the sidewall of the pocket and a battery cell received within the pocket.

### CROSS-REFERENCE TO RELATED APPLICATIONS

This application claims the benefit of U.S. Provisional Application No. 63/766,671, filed Mar. 4, 2025, the entirety of which is herein incorporated by reference.

### TECHNICAL FIELD

This disclosure relates generally to a cell holder of a traction battery pack and, more particularly, to utilizing at least one wedge to thermally interface with battery cells held by the cell holder.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a traction battery pack assembly, including: a cell holder assembly including a plurality of pockets, each pocket established by at least one sidewall that tapers inward from a first end region of the pocket toward an opposite second end region of the pocket, each pocket configured to receive at least one battery cell; and at least one wedge associated with each pocket, the at least one wedge disposed between the at least one sidewall of the pocket and the at least one battery cell received within the pocket.

In some aspects, the techniques described herein relate to a traction battery pack assembly, wherein the cell holder assembly is a polymer-based cell holder assembly, wherein the wedge is a metal or metal alloy.

In some aspects, the techniques described herein relate to a traction battery pack assembly, wherein the at least one wedge directly contacts the at least one battery cell and the at least one sidewall to facilitate thermal energy transfer therebetween.

In some aspects, the techniques described herein relate to a traction battery pack assembly, wherein each pocket includes an opening at the opposite second end region, the opening providing access to the at least one battery cell within the pocket.

In some aspects, the techniques described herein relate to a traction battery pack assembly, wherein the at least one wedge is tapered.

In some aspects, the techniques described herein relate to a traction battery pack assembly, wherein each pocket has a circular cross-section, and the at least one sidewall includes no more than one sidewall that tapers inward from the first end region to the second end region.

In some aspects, the techniques described herein relate to a traction battery pack assembly, wherein each pocket is a frustoconical pocket.

In some aspects, the techniques described herein relate to a traction battery pack assembly, wherein each pocket narrows in diameter from the first end region to the opposite second end region.

In some aspects, the techniques described herein relate to a traction battery pack assembly, wherein the at least one battery cell is at least one cylindrical battery cell.

In some aspects, the techniques described herein relate to a traction battery pack assembly, further including an enclosure cover and an enclosure tray, the cell holder assembly sandwiched between the enclosure cover and the enclosure tray.

In some aspects, the techniques described herein relate to a traction battery pack assembly, wherein enclosure cover, the enclosure tray, and the cell holder assembly are each polymer-based materials.

In some aspects, the techniques described herein relate to a traction battery pack assembly, wherein the cell holder assembly is configured to be immersed in a liquid thermal management fluid.

In some aspects, the techniques described herein relate to a traction battery pack assembly, wherein the cell holder assembly is attached directly to both the enclosure cover and the enclosure tray.

In some aspects, the techniques described herein relate to a traction battery pack assembly, including: a plurality of battery cells; a cell holder assembly including a plurality of pockets, each pocket receiving at least one of the battery cells, each pocket having a frustoconical shape; and at least one tapered thermal bridge disposed within each pocket, the at least one tapered thermal bridge having a first side contacting a sidewall of the pocket and an opposite second side in contact with the at least one battery cell received in the pocket, the at least one tapered thermal bridge configured to convey thermal energy between the at least one battery cell and the sidewall.

In some aspects, the techniques described herein relate to a traction battery pack assembly, wherein the at least one tapered thermal bridge includes a first tapered thermal bridge and a second tapered thermal bridge disposed within the pocket, the first and second tapered thermal bridge sandwiching the at least one battery cell disposed within the pocket.

In some aspects, the techniques described herein relate to a traction battery pack assembly, wherein each pocket narrows in diameter from a vertically upper end to a vertically lower end.

In some aspects, the techniques described herein relate to a traction battery pack assembly, wherein the plurality of battery cells are a plurality of cylindrical battery cells.

In some aspects, the techniques described herein relate to a traction battery pack assembly, further including an enclosure cover and an enclosure tray, the cell holder assembly sandwiched between the enclosure cover and the enclosure tray.

In some aspects, the techniques described herein relate to a traction battery pack assembly, wherein the cell holder assembly is immersed in a thermal management fluid.

In some aspects, the techniques described herein relate to a traction battery pack assembly, wherein the enclosure cover, the enclosure tray, and the cell holder assembly are polymer-based materials.

### BRIEF DESCRIPTION OF THE DRAWINGS

FIG. 1 schematically illustrates an electrified vehicle.

FIG. 2 illustrates a plurality of cylindrical battery cells relative to an electrified vehicle.

FIG. 3 illustrates a top perspective view of selected portions of a traction battery pack from the electrified vehicle of FIG. 1.

FIG. 4 illustrates a bottom perspective view of the portions of the traction battery pack shown in FIG. 3.

FIG. 5 illustrates a section view taken at line 5-5 in FIG. 3.

FIG. 6 illustrates a close-up view of an area of FIG. 5.

FIG. 7 illustrates a perspective view of the area of FIG. 6 showing at least one wedge, and a battery cell during installation.

FIG. 8 illustrates a section side view of a battery cell and at least one wedge being received within a pocket of the cell holder assembly from the traction battery pack of FIGS. 3-7.

FIG. 9 illustrates the section side view of the battery cell and the at least one wedge from FIG. 8 after being received within the pocket of the cell holder assembly.

### DETAILED DESCRIPTION

This disclosure relates generally to a cell holder assembly of a battery pack and to utilizing at least one wedge to facilitate thermal conductivity battery cells and the cell holder assembly.

The cell holder assembly includes pockets that receive the battery cells. In examples, the cell holder assembly can be a polymer-based structure. The cell holder assembly can be injection molded. The pockets can be drafted to facilitate release of the cell holder assembly from a mold cavity. The pockets, for example, may have sidewalls that are tapered.

The wedge can fit into each pocket to fill open areas between an outer surface of the battery cell and the sidewall. The wedge can transfer thermal energy between the battery cell and the sidewall. The wedge can help to retain the battery cell within a given one of the pockets. These and other benefits will be appreciated from the below.

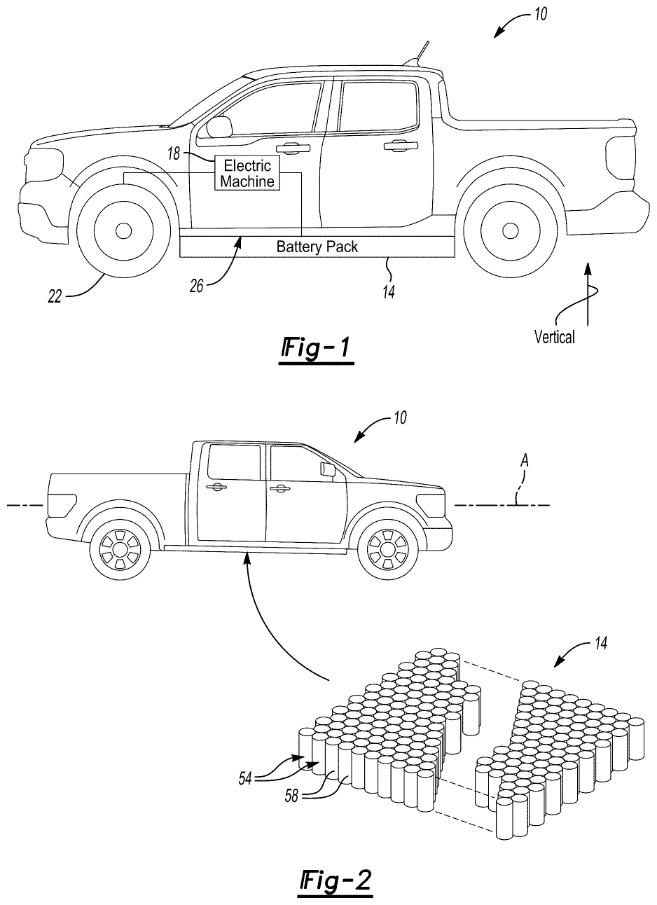

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference to FIG. 2, the battery pack 14 includes a plurality of individual battery cells 54. The battery cells 54 each include an outer case 58. The outer cases 58 can be a metal or metal alloy. The outer cases 58 are cylindrical, or substantially cylindrical, in this example. The battery cells 54 may be referred to as cylindrical battery cells. The battery cells 54 include terminals configured to electrically couple to other battery cells 54 and/or busbars, as examples, adjacent a common side thereof, which in this example is a top side.

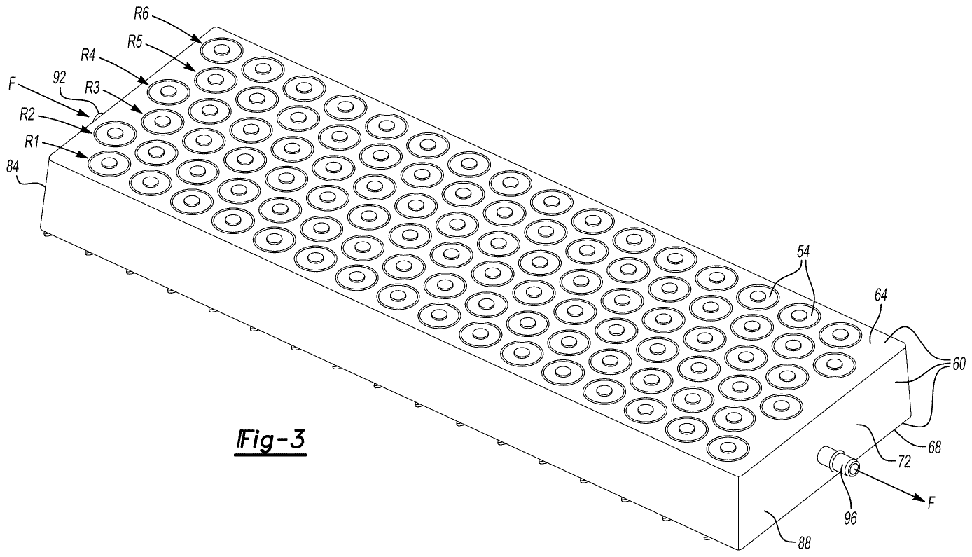

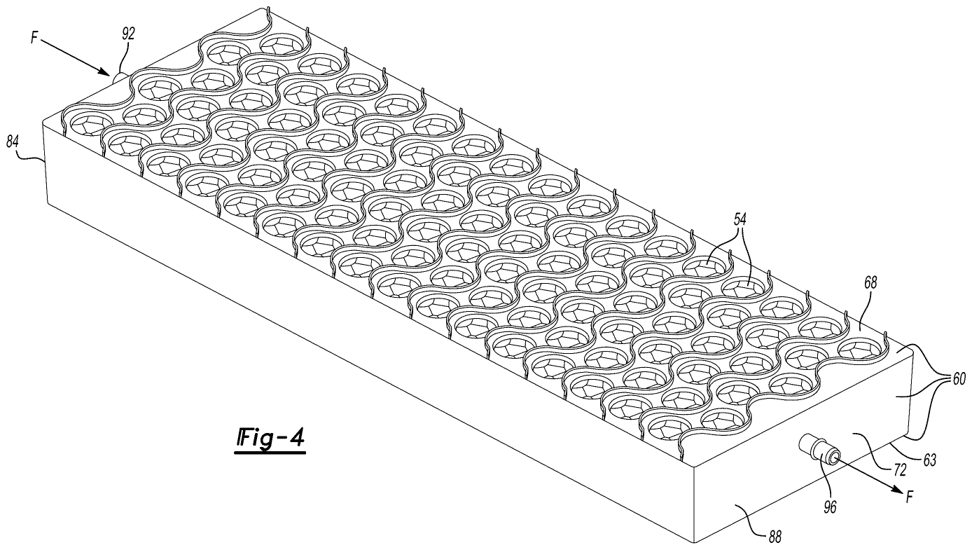

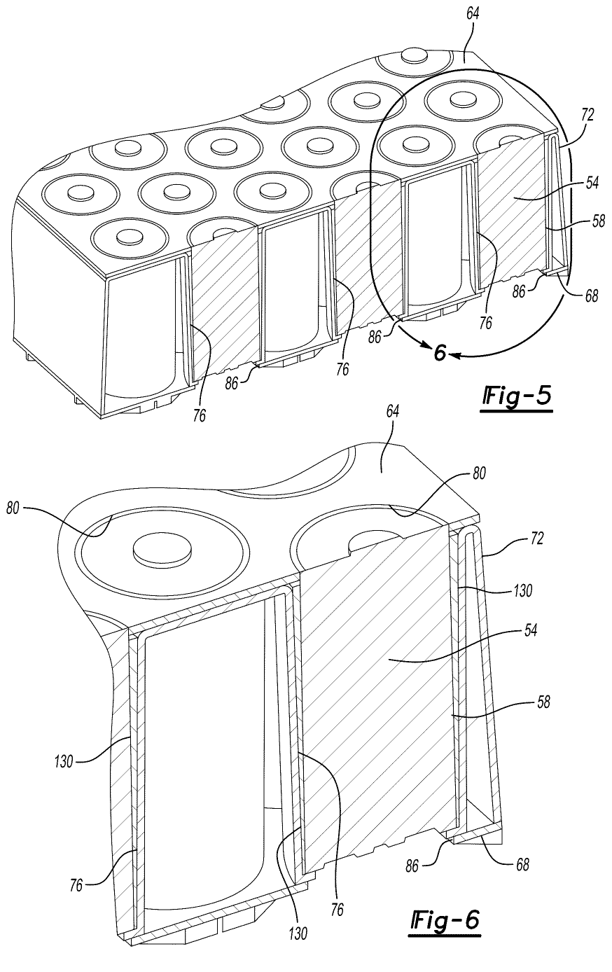

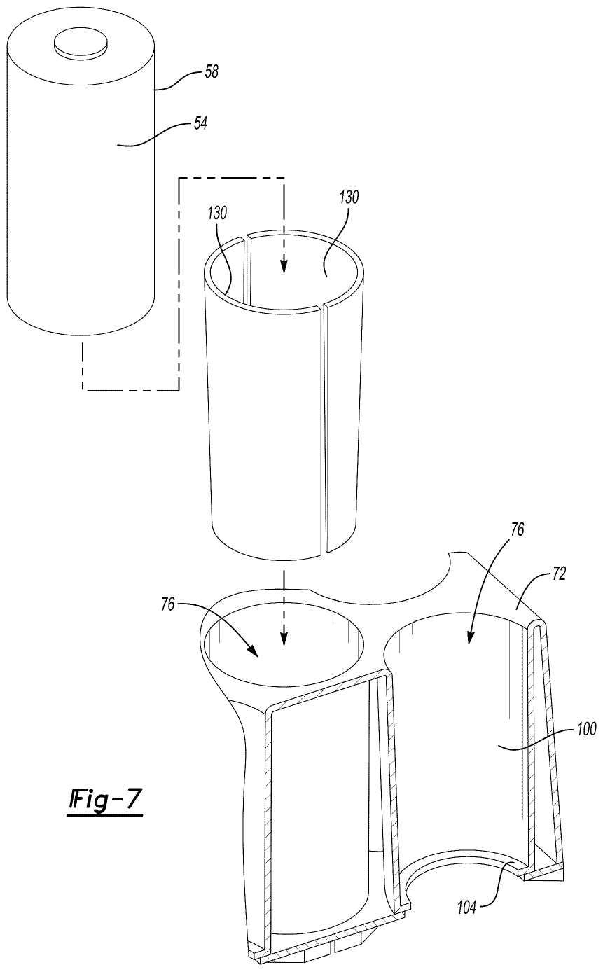

With reference now to FIGS. 3-6, the example battery pack 14 includes an enclosure assembly 60 having three primary components—a cover 64, a tray 68, and a cell holder assembly 72 sandwiched therebetween. The cover 64, the tray 68, and cell holder assembly 72 of the exemplary embodiment are each polymer-based materials. The cover 64, tray 68, and cell holder assembly 72 can be attached together using vibration welds, for example. Other fluid-tight connection techniques could be used in other examples.

The cell holder assembly 72 includes a plurality of pockets 76. The battery cells 54 are held within respective pockets 76 of the cell holder assembly 72. In this example, each of the pockets 76 holds one of the battery cells 54. In other examples, the pockets 76 could include hold more than one of the battery cells 54.

In this example, the battery cells 54 are arranged in rows R1-R6 that generally extend from a first end region wall 84 of the enclosure assembly 60, to a second end region wall 88 of the enclosure assembly 60. While there are six rows R1-R6 in this example, this disclosure extends to battery packs with different numbers of rows. Further, this disclosure is not limited to the particular number of battery cells in a particular row.

Rows R1-R6 are generally parallel to one another and, optionally, parallel to a longitudinal axis of the vehicle 10. Adjacent rows R1-R6 are staggered relative to one another to enable closer packaging of the battery cells 54, which results in the battery cells 54 being arranged in a generally honeycomb arrangement.

In this example, the battery cells 54 are arranged such that electrical connections between adjacent battery cells 54 are made on the sides of the battery cells 54 that face a top wall of the enclosure assembly 60. In this example, the cover 64 includes the top wall. The cover 64 includes a plurality of openings 80 in the top wall through which the battery cells 54 can be accessed to make, for example, electrical connections.

The tray 68 includes a plurality of openings 86 through which the battery cells 54 can expel vent byproducts during a thermal event. In some examples, the openings 86 may be covered until a thermal event leads to one or more of the battery cells 54 expelling vent byproducts.

In this example, an inlet 92 through the first end region wall 84 can receive a flow of liquid thermal management fluid F, such as a liquid coolant like water. The thermal management fluid F can move through the inlet 92 and into the open areas between the cover 64, the tray 68, and the cell holder assembly 72. The example cover 64 includes sidewalls that extend about the periphery of the battery cells 54 to contain the fluid F.

The thermal management fluid F can exit from battery pack 14 through an outlet 96 within the second end region wall 88. Within the battery pack 14, the thermal management fluid F can flow around the pockets 76 of the cell holder assembly 72 to take on thermal energy from the battery cells 54 and other components.

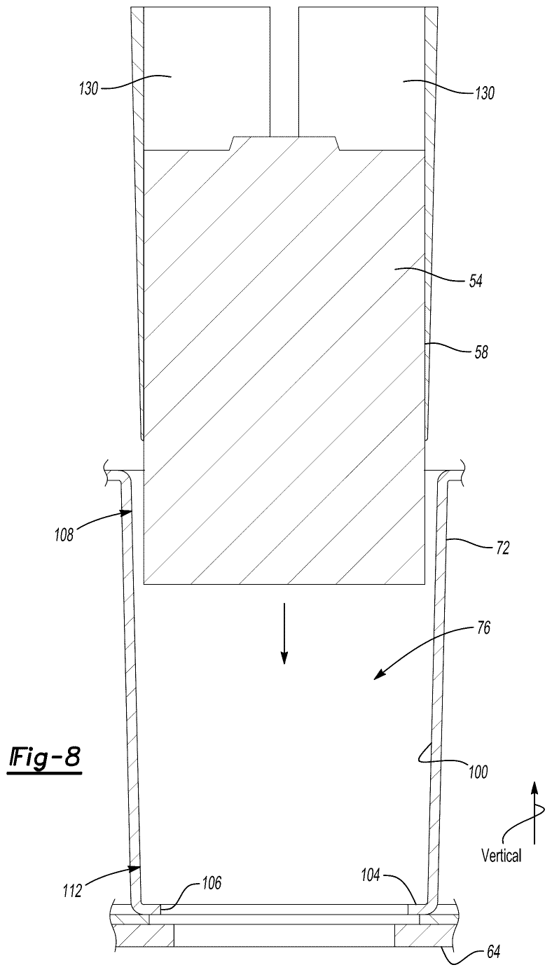

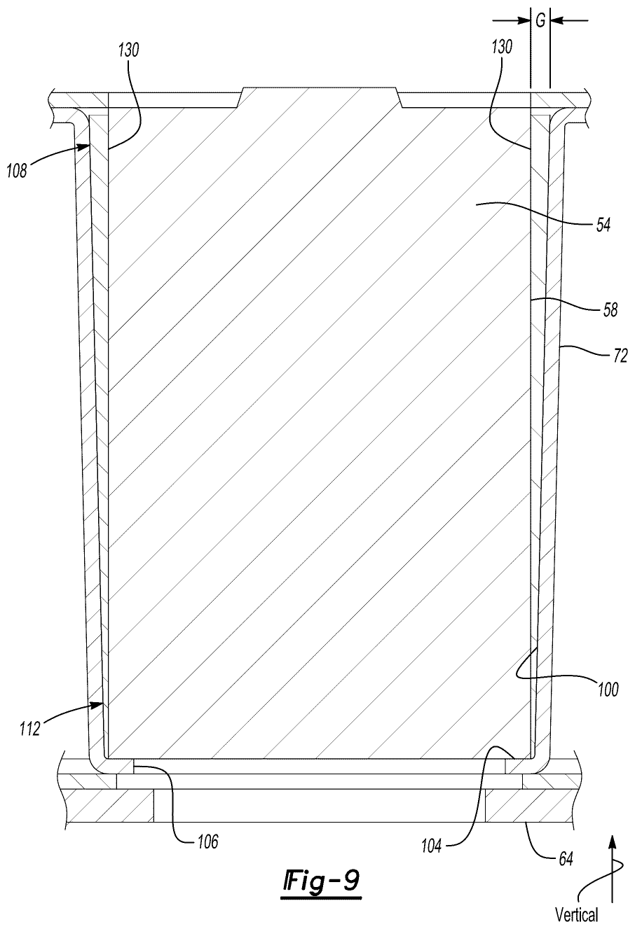

With reference now to FIGS. 7-9 and continuing reference to FIGS. 3-6, the pockets 76 of the example cell holder assembly 72 have a circular cross-section. Each of the pockets 76 includes a single sidewall 100 extending circumferentially continuously about a circumference of the respective one of the pockets 76. Cross-sections for the pockets 76 other than circular are possible and fall within the scope of this disclosure. For example, the pockets 76 could have a rectangular cross-sectional profile established by four distinct sidewalls.

For each of the pockets 76, the sidewall 100 extends upward from a floor 104 and tapers outward. The floor 104 includes an access opening 106 through which the respective battery cell 54 can vent. The access openings 106 are in registration with the openings 86 in the tray 68.

The tapering of the sidewall 100 gives the pockets 76 a draft angle, which can facilitate releasing of the cell holder assembly 72 from a mold during manufacturing. The tapering of the sidewalls 100 could instead or additionally be incorporated into the cell holder assembly 72 for other reasons, such as, for example, to facilitate insertion of the battery cell 54 into a respective one of the pockets 76.

The pockets 76 are frustoconical pockets in this example. In particular, each of the pockets 76 narrows in diameter from a first end region 108 of the pocket 76 to an opposite second end region 112 of the pocket 76. In this example, the first end region 108 is a vertically upper end of the pocket 76, and the second end region 112 is a vertically lower end of the pocket 76. The pockets 76 can also be said to taper inward from the first end region 108 to the second end region 112. Vertical, for purposes of this disclosure, is with reference to ground and a general orientation of the pockets 76 during operation when installed within the vehicle 10.

Due to the tapering of the sidewalls 100, a gap G between the sidewall 100 and the outer case 58 of the battery cell 54 is greater near the first end region 108 of the pocket 76 than at the second end region 112 of the pocket 76.

To facilitate thermal transfer across the gap G, at least one thermally conductive wedge 130 or shim is associated with each of the pockets 76, The wedge 130 can be disposed between the battery cell 54 and the sidewall 100. The wedge 130, when installed, directly contacts the outer case 58 of the battery cell 54 and the sidewall 100, which facilitates thermal energy transfer between the battery cell 54 and the sidewall 100.

In an example, thermal energy from the battery cell 54 is conveyed through the wedge 130 to the sidewall 100. The fluid circulating through the open areas of the battery pack 14 takes on this thermal energy from the sidewall 100. The fluid directly contacts the cell holder assembly 72, and the cell holder assembly 72 can be said to be immersed in the fluid.

After taking on thermal energy from the cell holder assembly, the fluid with the thermal energy is then moved through the outlet 96. This removes thermal energy from the battery cell 54 and can cool the battery cells 54 along with other components of the traction battery pack 14. In other examples, the fluid can be used to heat the battery cells 54.

To facilitate thermal transfer, the wedge 130 can be a metal or metal alloy material that is cast or stamped. In this example, each of the pockets 76 holds two thermally conductive wedges 130 that sandwich the at least one battery cell 54 held within that pocket 76. The two thermally conductive wedges 130 combine to provide a conical wedge assembly. Other numbers of the wedges 130 could be used in other examples.

In addition to facilitating thermal conductivity between the battery cells 54 and the cell holder assembly 72, the wedge 130 can help to position the battery cells 54 within the respective pockets 76. In some examples, the wedge 130 can be considered a tapered thermal bridge as the wedge 130 provides a bridge for a transfer of thermal energy between the sidewall 100 and the respective battery cell 54.

One of ordinary skill in this art would understand that the above-described embodiments are exemplary and non-limiting. That is, modifications of this disclosure would come within the scope of the claims. Accordingly, the following claims should be studied to determine their true scope and content.

1. A traction battery pack assembly, comprising:
a cell holder assembly including a plurality of pockets, each pocket established by at least one sidewall that tapers inward from a first end region of the pocket toward an opposite second end region of the pocket, each pocket configured to receive at least one battery cell; and
at least one wedge associated with each pocket, the at least one wedge disposed between the at least one sidewall of the pocket and the at least one battery cell received within the pocket.

2. The traction battery pack assembly of claim 1, wherein the cell holder assembly is a polymer-based cell holder assembly, wherein the wedge is a metal or metal alloy.

3. The traction battery pack assembly of claim 1, wherein the at least one wedge directly contacts the at least one battery cell and the at least one sidewall to facilitate thermal energy transfer therebetween.

4. The traction battery pack assembly of claim 1, wherein each pocket includes an opening at the opposite second end region, the opening providing access to the at least one battery cell within the pocket.

5. The traction battery pack assembly of claim 1, wherein the at least one wedge is tapered.

6. The traction battery pack assembly of claim 1, wherein each pocket has a circular cross-section, and the at least one sidewall includes no more than one sidewall that tapers inward from the first end region to the second end region.

7. The traction battery pack assembly of claim 1, wherein each pocket is a frustoconical pocket.

8. The traction battery pack assembly of claim 1, wherein each pocket narrows in diameter from the first end region to the opposite second end region.

9. The traction battery pack assembly of claim 1, wherein the at least one battery cell is at least one cylindrical battery cell.

10. The traction battery pack assembly of claim 1, further comprising an enclosure cover and an enclosure tray, the cell holder assembly sandwiched between the enclosure cover and the enclosure tray.

11. The traction battery pack assembly of claim 10, wherein enclosure cover, the enclosure tray, and the cell holder assembly are each polymer-based materials.

12. The traction battery pack assembly of claim 10, wherein the cell holder assembly is configured to be immersed in a liquid thermal management fluid.

13. The traction battery pack assembly of claim 12, wherein the cell holder assembly is attached directly to both the enclosure cover and the enclosure tray.

14. A traction battery pack assembly, comprising:
a plurality of battery cells;
a cell holder assembly including a plurality of pockets, each pocket receiving at least one of the battery cells, each pocket having a frustoconical shape; and
at least one tapered thermal bridge disposed within each pocket, the at least one tapered thermal bridge having a first side contacting a sidewall of the pocket and an opposite second side in contact with the at least one battery cell received in the pocket, the at least one tapered thermal bridge configured to convey thermal energy between the at least one battery cell and the sidewall.

15. The traction battery pack assembly of claim 14, wherein the at least one tapered thermal bridge includes a first tapered thermal bridge and a second tapered thermal bridge disposed within the pocket, the first and second tapered thermal bridge sandwiching the at least one battery cell disposed within the pocket.

16. The traction battery pack assembly of claim 14, wherein each pocket narrows in diameter from a vertically upper end to a vertically lower end.

17. The traction battery pack assembly of claim 14, wherein the plurality of battery cells are a plurality of cylindrical battery cells.

18. The traction battery pack assembly of claim 14, further comprising an enclosure cover and an enclosure tray, the cell holder assembly sandwiched between the enclosure cover and the enclosure tray.

19. The traction battery pack assembly of claim 18, wherein the cell holder assembly is immersed in a thermal management fluid.

20. The traction battery pack assembly of claim 18, wherein the enclosure cover, the enclosure tray, and the cell holder assembly are polymer-based materials.
